(19) United States
(12) Patent Application Publication
(10) Pub. No.: US 2002/0074681 A1
(43) Pub. Date: Jun. 20, 2002

(54) Dispersions of solid, semi-solid, and liquid resins and a method of making the same

(76) Inventors: Richard Allen Lundgard, Midland, MI (US); Robert D. Mussell, Midland, MI (US); Michael Anthony Jackson, Louisville, KY (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/002,448

(22) Filed: Nov. 15, 2001

Related U.S. Application Data
(60) Provisional application No. 60/249,760, filed on Nov. 17, 2000.

(51) Int. Cl. B29B 7/40; B29B 7/90; B29C 47/38

(52) U.S. Cl. 264/78; 264/211; 264/349

(57) ABSTRACT

Stable dispersions of solid, semi-solid, and liquid resins can be prepared by merging into a mechanical disperser a stream of a molten or liquid disperse phase with a stream of a molten or liquid continuous phase to form a dispersion or emulsion. A polymer that is preferably a solid at room temperature, but molten at some advanced temperature may be dispersed with low molecular weight polymers, or intermediate molecular weight polymers continuously in an extruder. A low polydispersity powder-slurry curable coating composition having volume average particle sizes of less than 10 μm may be prepared by the method of the present invention. Pigmentation of a powder-slurry coating composition is conveniently accomplished by adding pigment to the melted polymer, or to the continuous phase, or to the dispersion after the continuous phase is merged with the disperse phase.

### CROSS-REFERENCE STATEMENT

This application claims the benefit of U.S. Provisional application No. 60/249,760, filed Nov. 17, 2000.

### BACKGROUND OF THE INVENTION

The present invention relates to a continuous process of extruding and mechanically dispersing a solid polymeric resin in an aqueous or non-aqueous medium providing an efficient use of coating pigments, other organic and inorganic solid particulate components such as fillers, and facilitating incorporation of intermediate molecular weight resins, or even liquid resins in a dispersion with solid resins.

Preparation of a resin incorporating a pigment in a bulk polymerization process with polymerizable monomers is taught from United Kingdom Patent number 1,557,269 assigned to Nippon Paint Co., Ltd. Bulk polymerized resin incorporating pigment therein is subsequently incorporated in a batch suspension or emulsion polymerization. The pigment-dispersed resin composition may be dried, pulverized and powder coated. Alternatively, the pigment dispersed resin composition may be applied as an aqueous dispersion without drying and pulverization.

A process for the preparation of an aqueous powder-enamel dispersion suitable as a topcoat for automobile bodies is disclosed in U.S. Pat. No. 6,291,579. The powder slurry prepared is urged to be capable of curing at temperatures lower than 150° C. The disclosed process heats the resin components, there called cross-linkers and binders, in a separate container for each. Molten resin components are taught to be mixed and immediately emulsified in water. In addition to the resin components, other additives including catalysts, defoaming agents, dispersion agents, wetting agents, UV absorbers, antioxidants, pigments, and biocides may be included in the aqueous powder enamel dispersion.

Uniform dispersion of pigment in a pre-formed polymer is complicated by the challenge of uniform mixing of pigment and polymer necessary to accomplish uniform and repeatable color. It is reported in Pitture Vernici Eur. (1998), 74(1) under the title Organic Pigment Predispersions for Powder Coatings, Lewis, P. that it is not unusual for as much as twenty-five (25%) percent of the production of colored powdered resin to be reprocessed through the extruder to more fully disperse the color and achieve more reproducible color matches.

Imperfect mixing is thought to result from the fact that pigment remains solid, or remains solid longer by virtue of a higher melting point, in the melting polymer environment. The mechanical mixing action of the extruder is thought to agglomerate the pigment particles. Very high shear is required to breakdown and wet pigment agglomerates for effective distribution of pigments through the resin bulk. Scott, J. A. ed., The Science of Powder Coatings, vol. 2, Selective Industrial Training Associates Limited, London 1994, p. 261. In order to achieve color uniformity, high pigment loading, and corresponding cost is incurred.

It would therefore be an advance in the art to be able to prepare a stable aqueous dispersion of a solid resinous material in a continuous process directly from an extruder without first having to solidify, then melt, then mix and emulsify the resin. It would be a further advance in the art to be able to prepare a pigmented powder-slurry curable coating composition.

A further limitation in the manufacture of powdered coating compositions has been the required use of high molecular weight, solid resins in powdered coating compositions. These high molecular weight resins are characterized by being free flowing powders after having been ground. In contrast, low molecular weight resins are liquid at ambient conditions, while intermediate molecular weight resins are tacky, that is, they cease to be free-flowing powders under ambient conditions once they are ground. Consequently, low and intermediate molecular weight resins have traditionally not been used in powder coating compositions due to their consequent loss of the friability necessary for grinding to particle sizes of 10-100 μm traditionally considered necessary to make powder coatings.

It would therefore be an advance in the art to improve the efficiency with which pigment is added to a formulation. It would further be an advance in the art to prepare a stable aqueous dispersion of a solid resinous material in a continuous process directly from an extruder and to incorporate in the dispersion low molecular weight and intermediate molecular weight resin.

### SUMMARY OF THE INVENTION

The present invention addresses the problems in the art by providing a continuous method for preparing a stable dispersion or emulsion comprising the steps of a) continuously extruding in an extruder a polymer that is a solid at ambient temperatures under conditions of sufficient heat and shear to render the polymer molten; b) merging a stream of the molten polymer and a stream of a continuous phase into a mechanical disperser that is coupled to the extruder to form a dispersion or an emulsion of the molten polymer; and c) dispersing a pigment into any or all of i) the polymer in the extruder when the polymer is in a molten or semi-molten state, ii) the stream of the continuous phase prior to merging with the stream of the molten polymer, or iii) the merged stream containing the dispersion or emulsion of the polymer; wherein the polymer is self-dispersing or is stabilized in the continuous phase with a stabilizing amount of a surfactant that is added to the extruder or to the continuous phase.

In another aspect, the present invention is a continuous method for preparing a stable dispersion or emulsion comprising the steps of a) continuously extruding in an extruder i) a first polymer that is a solid at ambient temperatures under conditions of sufficient heat and shear to render the polymer molten; and ii) a second polymer that is either tacky or a liquid at ambient temperature; and b) merging a stream of the first polymer and the tacky or liquid polymer with a stream of a continuous phase into a mechanical disperser that is coupled to the extruder to form a dispersion or an emulsion of the polymers, wherein the polymers are self-dispersing or are stabilized in the continuous phase with a stabilizing amount of a surfactant that is added to the extruder or to the continuous phase.

### BRIEF DESCRIPTION OF DRAWINGS

FIG. 1 is a schematic of an extruder coupled to a mechanical disperser.

### DETAILED DESCRIPTION OF THE INVENTION

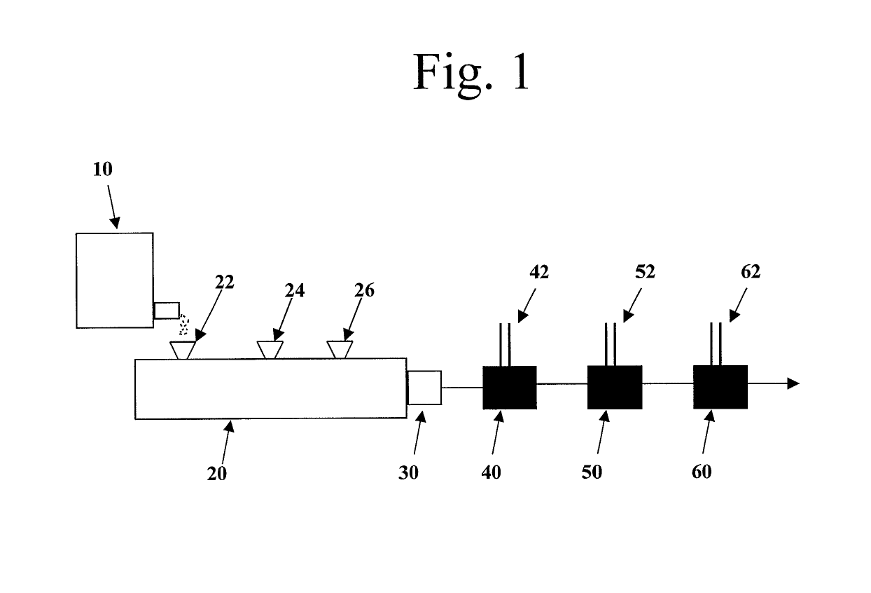

A preferred method of the present invention is depicted in FIG. 1. A twin screw melt or compound extruder 20 is coupled in series to optionally a gear pump 30, a disperser 40, optionally a first dilution mixer 50 and optionally a second dilution mixer 60. Resin in the form of powder or flakes is fed from the feeder 10 to an inlet 22 of the extruder 20 where the resin is melted or compounded. Where the resin is not self-dispersing, surfactant may be added to the resin through a separate inlet 24 of the twin screw extruder 20.

It may also be desirable to add through any of the inlets, preferably either of inlets 24 or 26, other materials such as liquid or tacky resins, or additives such as catalysts, dyes, fillers, flow control agents, degassing agents, and the like.

As stated above, tacky resins are resins that are solid at ambient conditions, but are sufficiently heat sensitive to be unsuitable for powder coating applications because of softening of the resin and consequent loss of friability necessary for grinding to particle sizes 10-100 μm traditionally considered for powder coating. Additionally, if methods such as cryogenic grinding are used to grind the tacky resins, these resins would not remain free-flowing powders under conditions of ambient temperature and humidity, and could therefore not be used in powder coating processes. Tacky resins and resins that are liquid at ambient temperatures may be used to make powder coatings according to the process of the present invention and as such provide improved properties over traditional powder coatings and powder coating manufacturing methods.

The resin melt is delivered to the optional gear pump 30 and merged with an initial stream of continuous phase, preferably water, flowing through a conduit 42 in the disperser 40. Surfactant may be added additionally or exclusively to the continuous phase stream. In one aspect of the invention, pigment such as titanium dioxide is added to any or all of a) the extruder 20 through any inlet where the resin is semi-molten (that is, not completely molten) or molten, b) the continuous phase stream 42 or c) the merged streams, either before or after further dilution. The streams may be diluted using a dilution mixer 50, and optionally diluted again in a second dilution mixer 60. Significantly, the continuous phase is not added into the twin screw extruder 20 but rather to a stream containing the resin melt after the melt has exited from the extruder. In this manner, steam pressure build-up in the extruder 20 is eliminated.

Examples of solid, tacky, or liquid polymeric resins include epoxy resins, poly(hydroxyaminoether) resins (PHAEs, as described in U.S. Pat. No. 5,834,078, which teachings are incorporated herein by reference), polyurethane resins, polyurethane-urea resins, polyester resins, acrylic resins, melamine resins, vinyl ether resins, polyolefins, ethylene-acrylic acid copolymers, or mixtures thereof or hybrids thereof. Factors such as molecular weight, crystallinity, polarity, and chain branching influence whether the polymer will be solid, tacky or liquid, as is well understood by those of ordinary skill in the art. For example, the solid resin may be an epoxy resin and the liquid or tacky resin may be a polyester resin, or vice-versa.

The polymer may require external surfactant, which may be anionic, cationic, or nonionic, or combinations of nonionic and anionic or nonionic and cationic surfactants. Alternatively, the polymer may be self-dispersing by virtue of the presence of ionic groups as described by McCollum et al. in U.S. Pat. No. 5,114,552, potentially ionic groups such as carboxylic acids and amines, or hydrophilic nonionic groups as described Markusch et al. in U.S. Pat. No. 4,879,322, column 9, lines 61-68, and columns 10-12. In some instances, it may be desirable to disperse the resins in the substantial absence of an external surfactant. As used herein, substantial absence means less than 0.1 percent of an external surfactant.

External surfactant, where required, can be added a) to the disperse phase; b) to the continuous phase; or c) to both. Generally, it is preferable to add surfactant to the disperse phase upstream of the disperser, more preferably through an inlet of the extruder as described in FIG. 1.

The molten or liquid continuous phase can be organic- or aqueous-based, and is preferably aqueous-based. The continuous phase and the disperse phase are sufficiently immiscible with each other so that stable dispersions or emulsions can be formed. Examples of a dispersion that contains a non-aqueous-based continuous phase is ethylene-acrylic acid in a polyether polyol and a polyolefin in a polyether polyol stabilized by a surfactant that contains structural units compatible with both the polyolefin and the polyol. The resin melt or liquid that has exited from the extruder forms the disperse phase stream, which is merged with the continuous phase stream, then delivered to a mechanical disperser. The ratio of the flow rate of the stream of the disperse phase (R₂) to the flow rate of the stream of the continuous phase (R₁) is advantageously set to minimize the polydispersity and the particle size of the stable aqueous dispersion. A description on how to form low particle size, low polydisperse stable emulsions and dispersions by a process of merging a stream containing a disperse phase with a stream containing a continuous phase is described by Pate et al. in U.S. Pat. No. 5,539,021, incorporated herein by reference. For enhanced stability of the dispersion or emulsion, the particle sizes of the present invention are preferably less than 10 μm, more preferably less than 5 μm, and most preferably less than 2 μm.

As Pate et al. discloses, it is desirable to prepare a high internal phase ratio emulsion (or, if the disperse phase solidifies out, a high internal phase dispersion) wherein the volume:volume ratio of the disperse phase to continuous phase is at least 74/26. In the case where water is the continuous phase, the high internal phase ratio emulsion is advantageously diluted with water to form a stable aqueous emulsion or dispersion. Such dispersions are suitable for coating applications.

As previously noted, pigment additions to the emulsion or dispersion may occur at various locations in the manufacture of the resin dispersion, provided the pigment addition occurs in a liquid or semi-molten phase of resin, or in the dispersion or emulsion. When pigment is added to the extruder, it is preferably added in concentrated form with a non-aqueous carrier fluid that facilitates handling and prevents agglomeration. Suitable non-aqueous carrier fluids include organic solvents, surfactants, and resins that can be homogeneously blended with the disperse phase resin. If, on the other hand, pigment is added with the continuous phase or to the dispersion or emulsion, water may be a preferred carrier, particularly where the continuous phase is aqueous based.

The addition of liquid and tacky resins for powder coatings result in improvements in flow and covering of the coated substrates. The improved flow need not result in softer coatings because the tacky and liquid resins may cross-link to build molecular weight during the curing of the coating, which may be by thermal or ultraviolet means, thereby improving the properties of the coatings. Introduction of liquid or tacky resins allows the use of a wider range of resin functionality than is currently available in traditional powder coating resins.

The process of the present invention provides a simple means of producing low or zero VOC-containing dispersions, preferably less than 10 percent, more preferably less than 5 percent, and most preferably less than 0.5 percent weight-to-weight based on the weight of the dispersion and the VOC components.

The following examples are for illustrative purposes only and are not intended to limit the scope of this invention.

### EXAMPLE 1

### Preparation of the Epoxy-Polyester Resin Dispersion

A dispersion of an epoxy-polyester resin blend is prepared in a continuous manner. The system includes a twin screw extruder to melt and forward the resin blend at 100° C. as well as to mix in the surfactant necessary to stabilize the dispersion. The resin blend contains a 50:50 mixture of a 2-type epoxy (Dow, DER 6224) and polyester (UCB, Crylcoat 340). The blend is fed into the extruder at a rate of 50 g/min. After melting, the blend is combined with 3.6 g/min of Atsurf 108 (ICI Surfactants) and 1.1 g/min of Disponil TA-430 (Henkel kGaA) nonionic surfactants. When the molten feed exits the extruder it is merged with a stream containing water and a surfactant flowing at a rate of 38 mL/min at 90° C. The water-surfactant stream is formed by merging an initial aqueous stream of water at 34 mL/min with an aqueous 10 percent solution of the surfactant sodium dodecylbenzene sulfonate (Aldrich) flowing at a rate of 4 mL/min. The merged streams are then fed into the inlet of a rotor-stator disperser (E. T. Oakes, N.Y.) operating at 800 rpm. The resulting dispersion is collected and its volume average particle size is 1.4 μm.

To prepare a formulated paint, first, a pigment is prepared by mixing together 96.9 parts water, 13.6 parts Tego Dispers 750W and 3.4 parts Tego Dispers 760W pigment dispersants (available from Tego Chemie Service USA, Randolph Road, Hopewell, Va.), 228 parts of Kronos 2160 rutile titanium dioxide (Kronos, Inc. Wyckoff Mills Road, Box 70 Hightstown, N.J. 08520), and 0.6 parts of DeeFo PI-4 defoamer (available from Ultra Additives, Inc., Straight Street, Patterson, N.J.). This first mixture is added by an inlet corresponding to 52 in FIG. 1 to 716 parts of the epoxy-polyester dispersion described above, with 1.6 parts of Byk 346 flow modifier (available from BYK Chemie USA, South Cherry Street, Wallingford, Conn.), and 10.3 parts of a 20 percent aqueous mixture of 2-methyl imidazole catalyst (available from BASF, Continential Drive, Mount Olive, N.J.) in a step corresponding to dilution mixer 50. The paint contains a volatile organic carbon content of 1.6 g/L.

The paint is coated onto cold rolled steel panels with a coating blade, flashed for 10 minutes and baked for 20 minutes at 300° F. (150° C.). The resulting coating has a thickness of 25 μm, a specular gloss at 60 degrees of 95, impact resistance of greater than 150 in/lbs (8.4 m/Kg) for direct, and greater than 120 in/lbs (6.7 m/Kg) for reverse, following ASTM D-2794 method for Resistance of Organic Coatings to the Effects of Rapid Deformation (Impact).

### EXAMPLE 2

### Preparation of the Epoxy-Polyester Resin Dispersion

A dispersion of an epoxy-polyester resin blend is prepared in a continuous manner. The resin blend consists of a 18:82 mixture of a liquid epoxy (Dow, DER 330) and solid polyester (UCB, Crylcoat 340). The liquid epoxy is introduced into the molten polyester in the extruder to give a total resin rate of 50 g/min. Tetronic 908 nonionic surfactant (BASF) is then added to the extruder at a rate of 6.9 g/min. The molten feed exits the extruder and is merged with a stream containing water and a surfactant flowing at a rate of 44 mL/min at 90° C. The water-surfactant stream is prepared by merging an initial aqueous stream of water at 40 mL/min with a 20 percent solution of the surfactant Aerosol OT-75 (Cytec Industries) in 25 percent ethanol-water mixture flowing at a rate of 4 mL/min. The merged streams are then fed into the inlet of a rotor-stator disperser (E. T. Oakes, N.Y.) operating at 800 rpm. The resulting dispersion is collected and its volume average particle size is found to be 3 micrometers.

To prepare a clear aqueous based coating the dispersion is diluted to 47 percent solids, filtered through 150 mesh wire screen and coated onto cold rolled steel panels with a coating blade, flashed for 10 minutes and baked for 20 minutes at 300° F. The resulting coating has a thickness of 25 microns and impact resistance of greater than 160 in/lbs (8.9 m/Kg) for direct, following ASTM D-2794 method for Resistance of Organic Coatings to the Effects of Rapid Deformation (Impact).

What is claimed is:

1. A continuous method for preparing a stable dispersion or emulsion comprising the steps of a) continuously extruding in an extruder a polymer that is a solid at ambient temperatures under conditions of sufficient heat and shear to render the polymer molten; b) merging a stream of the molten polymer and a stream of a continuous phase into a mechanical disperser that is coupled to the extruder to form a dispersion or an emulsion of the molten polymer; and c) dispersing a pigment into any or all of i) the polymer in the extruder when the polymer is in a molten or semi-molten state, ii) the stream of the continuous phase prior to merging with the stream of the molten polymer, or iii) the merged stream containing the dispersion or emulsion of the polymer; wherein the polymer is self-dispersing or is stabilized in the continuous phase with a stabilizing amount of a surfactant that is added to the extruder or to the continuous phase.

2. The method of claim 1 wherein the pigment is added to the molten polymer in the extruder.

3. The method of claim 1 wherein pigment is added to the stream of the continuous phase prior to merging with the stream of the molten polymer.

4. The method of claim 1 wherein pigment is added to the merged stream containing the dispersion or emulsion of the polymer.

5. The method of claim 1 which further comprises the step of adding into the extruder a polymer that is liquid or tacky at ambient temperatures.

6. The method of claim 1 wherein the continuous phase contains water, and the disperse phase contains an epoxy resin, a poly(hydroxyaminoether) resin, a polyurethane resin, a polyurethane-urea resin, a polyester resin, an acrylic resin, a melamine resin, a vinyl ether resin, a polyolefin, an ethyleneacrylic acid copolymer, or hybrids thereof or mixtures thereof.

7. The method of claim 6 wherein the disperse phase contains a hybrid or a blend of an epoxy resin and a polyester resin.

8. A continuous method for preparing a stable dispersion or emulsion comprising the steps of a) continuously extruding in an extruder i) a first polymer that is a solid at ambient temperatures under conditions of sufficient heat and shear to render the polymer molten; and ii) a second polymer that is either tacky or a liquid at ambient temperature; and b) merging a stream of the first polymer and the tacky or liquid polymer with a stream of a continuous phase into a mechanical disperser that is coupled to the extruder to form a dispersion or an emulsion of the polymers, wherein the polymers are self-dispersing or are stabilized in the continuous phase with a stabilizing amount of a surfactant that is added to the extruder or to the continuous phase.

9. The method of claim 8 wherein the second polymer is added to the first polymer when the first polymer is molten.

10. The method of claim 8 which further includes the step of adding pigment into any or all of i) the first polymer in the extruder when the polymer is in a molten or semi-molten state, ii) the stream of the continuous phase prior to merging with the stream of the molten polymer, or iii) the merged stream containing the dispersion or emulsion of the polymer.

11. The method of claim 8 wherein the first polymer and the tacky or liquid resins are each independently an epoxy resin, a poly(hydroxyaminoether) resin, a polyurethane resin, a polyurethane-urea resin, a polyester resin, an acrylic resin, a melamine resin, a vinyl ether resin, a polyolefin, an ethyleneacrylic acid copolymer, or hybrids thereof or mixtures thereof.

12. The method of claim 8 wherein the first polymer and the tacky or liquid resins are each independently a polyester resin and an epoxy resin.

13. The method of claim 8 wherein the dispersion has a volume average particle size of less than 10 μm.

14. The method of claim 13 wherein the dispersion has a volume average particle size of less than 5 μm.

15. The method of claim 14 wherein the dispersion has a volume average particle size of less than 2 μm.
